(19) United States
(12) Patent Application Publication
(10) Pub. No.: US 2020/0108654 A1
(43) Pub. Date: Apr. 9, 2020

(54) MULTIPURPOSE DRAWING TOOL

(71) Applicant: William Gates, Worcester, MA (US)

(72) Inventor: William Gates, Worcester, MA (US)

(21) Appl. No.: 16/153,151

(22) Filed: Oct. 5, 2018

(51) Int. Cl. B43L 7/033; B43L 7/027

(52) U.S. Cl. CPC B43L 7/033; B43L 13/205; B43L 7/0275

(57) ABSTRACT

Embodiments herein are directed to a spatially efficient, multipurpose drawing tool adapted for creating architectural design drawings and capable of drawing lines at regular 15 degree intervals without requiring mechanical reconfiguration. The multipurpose drawing tool is arranged, dimensioned and organized as four sides with a concave vertex opposite three convex vertices, one of which has an angle of 90 degrees and may be quickly manipulated to draw a line at any 15 degree interval, e.g., 15°, 30°, 45°, 60°, 75°, and 90°. The multipurpose drawing tool may also include an aperture having a diameter sized according to a scale for drawing arcs, such as a semi-circular arc depicting a door swing in scaled architectural drawings. The multipurpose drawing tool also addresses a problem of chipped or bent tips for drawing tool vertices (e.g., traditional 30-60-90 triangles and 45-45-90 triangles) by cleaving a portion of each tip.

### BACKGROUND

### Technical Field

The present invention relates to drafting instruments and, more particularly, to a drafting instrument such as a multipurpose drawing tool.

### Background Information

Drafting instruments such as drawing tools have existed since the Renaissance for inscribing lines at fixed angles. Generally, these tools provide a limited number of angles and, thus, typically require a draftsman to utilize and exchange various tools frequently while preparing a drawing, such as an architectural design drawing.

Historically, creation of an architectural design drawing has employed two standard drawing tools—a 30-60-90 triangle and a 45-45-90 triangle. FIG 1A illustrates a traditional 45-45-90 triangle 100 with 45° angles 110a,b and a 90° angle 120. This triangle has the capability to draw lines angles at 45° angles as depicted in FIG. 1B. FIG. 2A illustrates a traditional 30-60-90 triangle 200 with 30° angle 210b, a 60° angle 210a, and a 90° angle 220. This triangle has the capability to draw lines at 30° intervals as depicted in FIG. 2B.

These standard tools are widely used by skilled designers, such as architects, interior designers, graphic designer, fashion designer, engineer, builder, carpenter and students of these arts, to create drawings with various angles and perspectives. For example, these tools may assist the designer in drawing common angles that have become standard throughout the history of architecture and design. In addition, these tools have been traditionally used to create mechanical drawings generally rendered in one or more conventional projections (e.g., orthographic projection, oblique projection, perspective projection, and axonometric projection). Thus, draftspersons and artists alike typically use a variety of drawing tools to render angles needed to create the various perspectives. However, it is well known in the graphic design arts that these standard drafting tools (i.e., triangles) are susceptible to chipping and/or bending at the vertices that leads to less accurate drawing of lines due lack of adequate alignment with the drawing. Moreover, it is often cumbersome, even for a skilled designer, to switch between these drafting tools especially when drawing, for example 45° and 30°/60° angles.

Thus, there is a need for a drafting instrument, such as a drawing tool, which is inexpensive, portable, and simple-to-use. In addition, there is a need for a drawing tool which may be used to render angles at 15° intervals to support drawing conventional projections used by skilled designers, such as architects, interior designers, graphic designer, fashion designer, engineer, builder, carpenter and students of these arts.

### BRIEF DESCRIPTION OF THE DRAWINGS

The above and further advantages of the embodiments herein may be better understood by referring to the following description in conjunction with the accompanying drawings in which like reference numerals indicate identically or is functionally similar elements, of which:

FIG. 1A illustrates a traditional 45-45-90 triangle;

FIG. 1B illustrates a capability of the traditional 45-45-90 triangle to draw lines;

FIG. 2A illustrates a traditional 30-60-90 triangle;

FIG. 2B illustrates a capability of the traditional 30-60-90 triangle to draw lines;

FIG. 3A illustrates an embodiment of a multipurpose drawing tool with 15-30-45-60-75-90 angles to draw lines;

FIG. 3B illustrates a capability of the multipurpose drawing tool to draw lines at regular 15° intervals;

FIG. 4 illustrates a top view of a detailed configuration and arrangement of the multipurpose drawing tool; and

FIG. 5 illustrates an orthographic view of an embodiment of the multipurpose drawing tool detailing cleaved apex points.

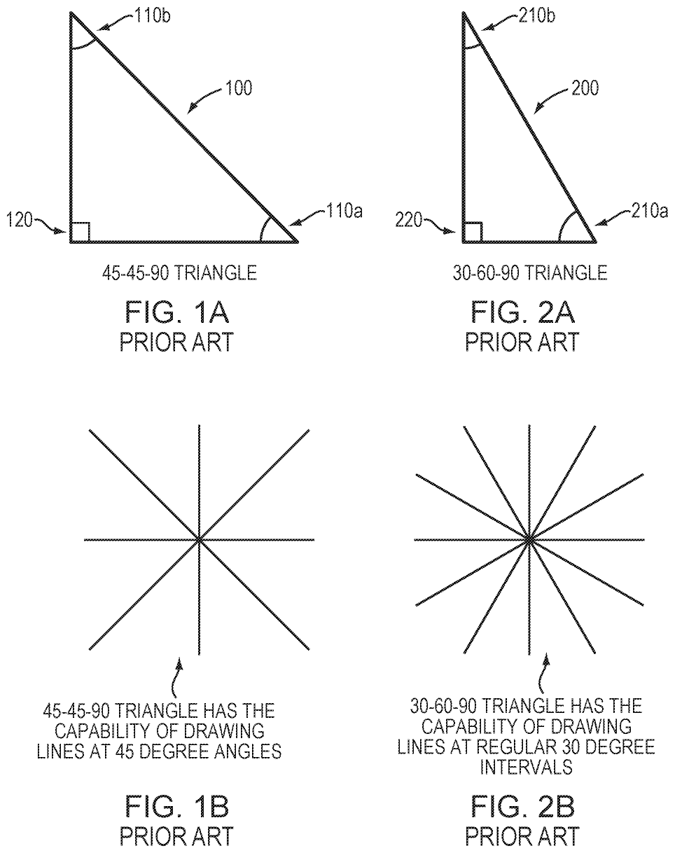

### OVERVIEW

Embodiments herein are directed to a spatially efficient, multipurpose drawing tool adapted for creating architectural design drawings and, to that end, capable of drawing lines at regular 15 degree intervals without requiring mechanical reconfiguration. The multipurpose drawing tool is illustratively arranged, dimensioned and organized as four sides with a concave vertex opposite three convex vertices, one of which has an angle of 90 degrees and may be quickly manipulated to draw a line at any 15 degree interval, e.g., 15°, 30°, 45°, 60°, 75°, and 90°. In an embodiment, the multipurpose drawing tool may include a glide (e.g., a bevel) on one or more of the sides as a guide for a marking tool (e.g., a pencil, pen, marker and the like) to draw the line. The multipurpose drawing tool may also include an aperture, e.g., a round hole, having a diameter sized according to a scale for drawing arcs, such as a semi-circular arc depicting a door swing in scaled architectural drawings, e.g., ¼″=1′. For example, to draw an arc depicting a 3 ft wide door swing to a ¼″=1′ scale, the aperture radius may be ¾″ (i.e., 3 times ¼″). As such, the multipurpose drawing tool provides extended capabilities beyond that found in traditional drawing tools, such as the 30-60-90 triangle and the 45-45-90 triangle, by allowing any 15 degree angular interval to be drawn using a single tool that is easily oriented and manipulated.

The multipurpose drawing tool also addresses a problem of chipped or bent tips (i.e., apexes) for angles relying on the drawing tool vertices (e.g., 15° and 75°) by cleaving a portion of each tip. When a tip of a drawing tool is chipped or bent, accuracy for angles created in a drawing diminishes because the damaged edge of the tool tip cannot be as accurately aligned to other elements depicted in the drawing. For example, the multipurpose drawing tool with a chipped tip (i.e., a broken apex or vertex) proximate the angle creating 15°/75° may not be used to accurately draw a 15°/75° line because a damaged portion near the apex (i.e., the chipped tip) along the length of at least one edge forming the 15°/75° angle of the drawing tool cannot align to the drawing to form an accurate 15°/75° angle. That is, an angle intended to be drawn to 15°/75° may be inaccurately drawn instead, for example, at 17° using a chipped triangle tool, thereby resulting in lower accuracy and deviation from the intended angle to be drawn, e.g., 15°. Note that an amount (i.e., size) of a cleaved portion of the apex is determined such that affected drawing angles retain their accuracy within a tolerance. In an embodiment, a size of the cleaved portion is less than 10% of a length of the side of the drawing tool being cleaved.

The multipurpose drawing tool may be constructed from a variety of materials including, but not limited to: acrylic, metals such as aluminum and steel, plastic, polycarbonate, polystyrene and combinations thereof. In an embodiment, the glide is constructed from steel inserted into a slot formed within one or more of the four edges, and a body of the drawing tool is constructed from acrylic. In an alternate embodiment, the glide may be embodied as a bevel on one or more of the edges.

The multipurpose drawing tool may be used to assist in the creation of orthographic, axonometric, perspective and oblique perspective drawings without the use of additional tools. Advantageously, the multipurpose drawing tool replaces existing tools, such as the 30-60-90 triangle and the 45-45-90 triangle, and thus permits faster, more efficient drawing by a skilled designer, such as an artist or draftsperson, as only one tool need be manipulated.

### DESCRIPTION

As used herein, terms have their generally understood definitions and meanings. In particular, with regard to the definitions of angles, an “acute” angle is one having a value greater than 0°, but less than 90°; an “obtuse” angle is one having a value greater than 90°, but less than 180° degree; and a “reflex” angle is one having a value greater than 180°, but less than 360°. An “interior” angle or an “inside” angle is an angle formed between two adjacent sides of a rectilinear figure such as a polygon, and lying wholly within the polygon. An angle is said to be an “outside” angle with respect to a polygon if it is an angle formed by two adjacent sides of the polygon, but lying wholly outside the polygon. As used herein an apex denotes a highest point in a meeting of two sides of a polygon; and an anti-apex denotes a point furthest away from a meeting of two sides of a polygon.

Two angles are said to be “complementary” if the sum of their values forms a right angle of 90°. Similarly, two angles are said to be “supplementary” if their sum is a straight angle of 180°.

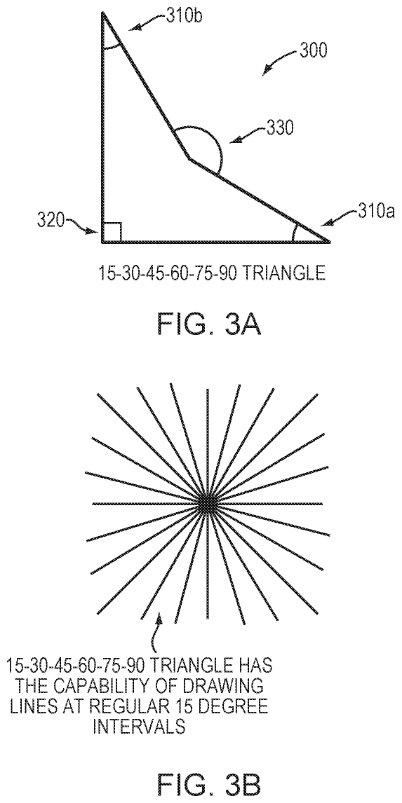

FIG. 3A illustrates an embodiment of a multipurpose drawing tool with 15-30-45-60-75-90 angles adapted to draw lines. Illustratively, the multipurpose drawing tool is arranged, dimensioned and organized as four sides with a concave apex (i.e., having an obtuse exterior angle) subtending an angle 330 having 150° that is opposite an anti-apex forming a right angle 320 and including isosceles angles 310a,b of 30°. The multipurpose drawing tool may be quickly manipulated (e.g., by hand) to draw a line at any 15 degree interval, e.g., 15°, 30°, 45°, 60°, 75°, and 90°.

FIG. 3B illustrates a capability of the multipurpose drawing tool to draw lines at regular 15° intervals. Whereas the traditional 45-45-90 drawing tool (e.g., triangle) divides the standard quadrant of the Cartesian grid into two sections (e.g., a 45°-90°) and the traditional 30-60-90 triangle divides that quadrant into three sections (e.g., 30°-60°-90°), the multipurpose drawing tool divides the standard quadrant of the Cartesian grid into six sections (15°-30°-45°-60°-75°-90°) and, thus, provides the capability of drawing lines at regular 15° intervals, as shown in FIG. 3B. This capability of the multipurpose drawing tool offers the designer (user) greater flexibility in the design process, as well as ease of use. For example, to draw a line at 15° the vertices having the isosceles angles 310a,b may be aligned on a drawing so that an edge forming the concave vertex of the multipurpose drawing tool and a line between the vertices of the isosceles angles 310a,b subtends a 15° angle. As a result, the edge may be used to guide a marking instrument to draw the line at 15°.

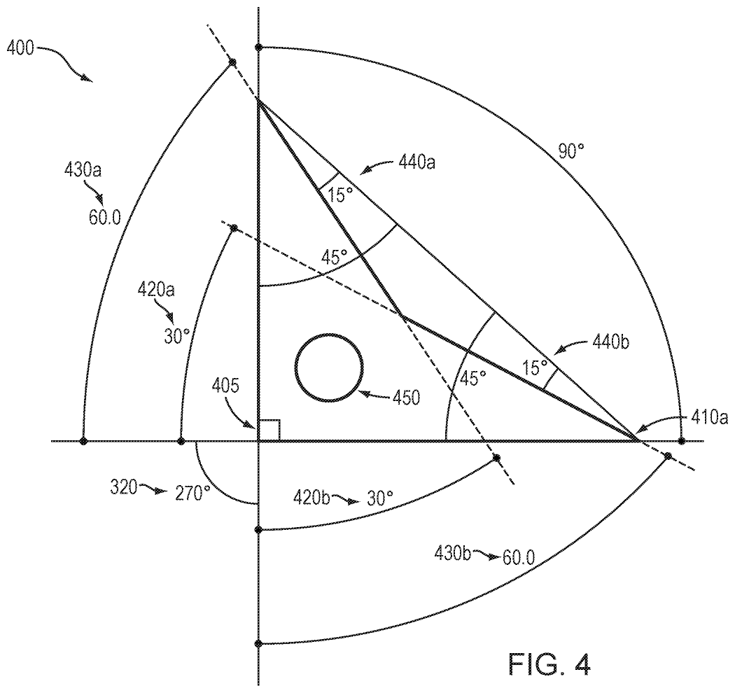

FIG. 4 illustrates a top view of a detailed configuration and arrangement of the multipurpose drawing tool. The multipurpose drawing tool may be embodied as quadrilateral shape having an interior angle of 90° formed at a vertex 405 opposite a convex vertex 415 forming an exterior angle of 150° (i.e., an interior angle of 210°) and having two additional vertices 410a,b forming interior isosceles angles of 30° 420a,b. That is, a first pair of sides form a concave apex subtending an angle having 150° opposite a second pair of sides forming an anti-apex having a right angle and including isosceles angles of 30°. The top view also illustrates how the angles 15°, 30°, 45°, 60°, 75° and 90° may be aligned for drawing. As described above, a 15° angle may be drawn by aligning the vertices having the isosceles angles 410a,b on a drawing so that an edge forming the concave vertex 415 and a line between the vertices of the isosceles angles 410a,b subtends a 15° angle 440a,b.

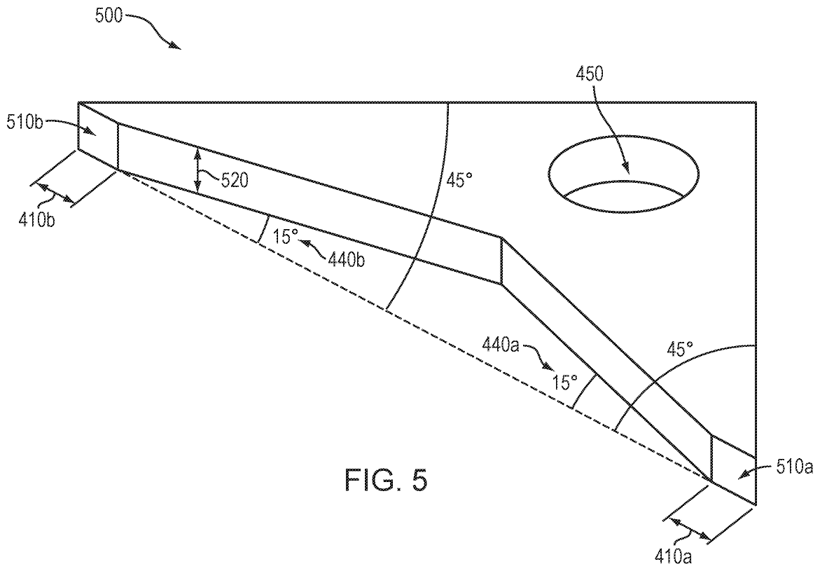

FIG. 5 illustrates an orthographic view of an embodiment of the multipurpose drawing tool detailing cleaved apex points. As described above, the multipurpose drawing tool is arranged, dimensioned and organized to cleave a portion of the tip (apex) to avoid chipping or bending of the edge of the tool tip, so as to reduce a loss of accuracy of when drawing some angles. Faces 510a,b of the cleave portion may align an imaginary line subtending the 15° of angles 440a,b. Illustratively, a size of the cleave portion 410a,b may range approximately between ¼″ (one quarter inches) and ½″ in proportion to a size of the multipurpose drawing tool. Note that an amount (i.e., size) of a cleaved portion of the apex may be determined such that affected drawing angles retain their accuracy within a manufactured tolerance (e.g., ±0.1°). In an embodiment, a size of the cleaved portion is less than 10% of a length of the side of the drawing tool being cleaved. A thickness of the multipurpose tool may also range approximately between ⅛″ and ¼″. However, as is understood by persons of skill in the art, numerous other embodiments may be envisaged having greater and lesser ranges for thickness and cleave size of the drawing tool without departing from the spirit and scope of the invention.

In an embodiment, the multipurpose drawing tool may include a glide (e.g., a bevel) on one or more of the sides as a guide for a marking tool (e.g., a pencil, pen, marker and the like) to draw the line. The multipurpose drawing tool may also include an aperture 450, e.g., a round hole, having a diameter sized according to a scale for drawing arcs, such as a semi-circular arc depicting a door swing in scaled architectural drawings, e.g., ¼″=1′. For example, to draw an arc depicting a 3 ft wide door swing to a ¼″=1′ scale, the aperture radius may be ¾″ (i.e., 3 times ¼″). As such, the multipurpose drawing tool provides extended capabilities beyond that found in traditional drawing tools, such as the 30-60-90 triangle and the 45-45-90 triangle, by allowing any 15 degree angular interval to be drawn using a single tool that is easily oriented and manipulated.

The multipurpose drawing tool may be constructed from a variety of materials including, but not limited to: acrylic, metals such as aluminum and steel, plastic, polycarbonate, polystyrene and combinations thereof. In an embodiment, the glide is constructed from steel inserted into a slot formed within one or more of the four edges, and a body of the drawing tool is constructed from acrylic. In an alternate embodiment, the glide may be embodied as a bevel on one or more of the edges (sides) to guide a marking instrument.

Note that all dimensions and angles disclosed herein are understood to mean within a manufactured tolerance, for example 15° may range by ±0.1° or from 14.9° to 15.1°. Manufactured tolerances may range, depending on the type of material and cost of manufacturing, typically from a 0.01% to 2% of a thickness of the material.

The multipurpose drawing tool may be used to assist in the creation of orthographic, axonometric, perspective and oblique perspective drawings without the use of additional tools. Advantageously, the multipurpose drawing tool replaces existing tools, such as the 30-60-90 triangle and the 45-45-90 triangle, and thus permits faster, more efficient drawing by a skilled designer, such as an artist or draftsperson, as only one tool need be manipulated.

What is claimed is:

1. A drawing tool apparatus comprising:
a first pair of sides forming a concave apex subtending an angle having 150° to a manufactured tolerance opposite a second pair of sides forming an anti-apex having a right angle and including isosceles angles of 30° to the manufactured tolerance; and
a cleave portion formed from at least one of the isosceles angles.

2. The drawing tool apparatus of claim 1 further comprising:
an aperture sized to scaled architectural drawings.

3. The drawing tool apparatus of claim 1 wherein a face of the cleave portion has a dimension less than 10% of a length of the first pair of sides.

4. The drawing tool apparatus of claim 1 wherein a face of the cleave portion aligns an imaginary line subtending 15° to the manufactured tolerance between apexes of the isosceles angles.

5. The drawing tool apparatus of claim 1 wherein the apparatus is capable to be aligned to a drawing so as to hand draw a line with an angle at 15°, 30°, 45°, 60°, 75° and 90°.

6. The drawing tool apparatus of claim 1 made from a material selected from the group of acrylic, steel, plastic, polycarbonate, and polystyrene.

7. The drawing tool apparatus of claim 1 wherein one or more of the sides includes a bevel to guide a marking instrument.

8. The drawing tool apparatus of claim 1 wherein one or more sides includes a metal glide in a slot of the one or more sides.

9. The drawing tool apparatus of claim 1 wherein the manufactured tolerance ranges from 0.01% to 2% of a thickness of the drawing tool.

10. The drawing tool apparatus of claim 1 wherein the manufactured tolerance ranges from ±0.1°.

11. The drawing tool apparatus of claim 1 wherein the aperture has a radius of at least ¾ inches.

12. The drawing tool apparatus of claim 1 wherein a face of the cleave portion has a dimension ranging from ⅛ inches to ¼ inches.

13. A drawing tool apparatus comprising:
a first pair of sides forming a concave apex subtending an angle having 150° to a manufactured tolerance opposite a second pair of sides forming an anti-apex having a right angle and including isosceles angles of 30° to the manufactured tolerance, wherein the apparatus is capable to be aligned to a drawing so as to hand draw a line with an angle at 15°, 30°, 45°, 60°, 75° and 90° ; and
a cleave portion formed from each of the isosceles angles, wherein a face of the cleave portion aligns an imaginary line subtending 15° between apexes of the isosceles angles, and wherein a face of the cleave portion has a dimension less than 10% of a length of the first pair of sides.

14. The drawing tool apparatus of claim 13 further comprising:
an aperture sized to scaled architectural drawings.

15. The drawing tool apparatus of claim 13 wherein one or more of the sides includes a bevel to guide a marking instrument.

16. A drawing tool apparatus comprising:
a first pair of sides forming a concave apex subtending an angle having 150° to a manufactured tolerance opposite a second pair of sides forming an anti-apex having a right angle and including isosceles angles of 30° to the manufactured tolerance, wherein the apparatus is capable to be aligned to a drawing so as to hand draw a line with an angle at 15°, 30°, 45°, 60°, 75° and 90° ; and
an aperture sized to scaled architectural drawings.

17. The drawing tool apparatus of claim 16 wherein the manufactured tolerance ranges from ±0.1°.

18. The drawing tool apparatus of claim 16 further comprising a cleave portion formed from at least one of the isosceles angles, wherein a face of the cleave portion has a dimension less than 10% of a length of the first pair of sides.

19. The drawing tool apparatus of claim 16 wherein the aperture has a radius of at least ¾ inches.

20. The drawing tool apparatus of claim 16 wherein one or more of the sides includes a bevel to guide a marking instrument.
